(19) United States
(12) Patent Application Publication
(10) Pub. No.: US 2009/0246999 A1
(43) Pub. Date: Oct. 1, 2009

(54) ELECTRICAL CONNECTOR LATCH WITH SPRING

(76) Inventors: Larry M. Crofoot, Perry, OH (US); John T. Venaleck, Painesville, OH (US)

Correspondence Address: Jonathan A. Platt;Renner, Otto, Boisselle & Sklar, LLP, 1621 Euclid Ave. - 19th Floor, Cleveland, OH, 44115, US

(21) Appl. No.: 12/409,798

(22) Filed: Mar. 24, 2009

Related U.S. Application Data
(60) Provisional application No. 61/039,935, filed on Mar. 27, 2008.

(51) Int. Cl. H01R 13/627

(52) U.S. Cl. 439/352; 439/350

(57) ABSTRACT

An electrical connector has a latch mechanism that includes a pair of hooks that move resiliently outward from the center line of the connector, and a pair of axial springs mechanically coupled to latch mechanism. The axial springs provide force in a direction substantially parallel to the center line of the connector. The axial springs are compressed during initial parts of the process of mating of the connector with a receptacle or other connector. The energy from the compressed springs is then used to pull the connector and the receptacle more tightly together after the initial insertion. The spring forces maintain a tight grip between the connector and the receptacle, avoiding the play that is generally found in hook-based electrical connector latching mechanism. The latching mechanism provides a secure mechanical coupling between the connector and the receptacle, such as been previously obtained in screw-based couplings.

This application claims priority under 35 USC 119 to U.S. Provisional Application No. 61/039,935, filed Mar. 27, 2008, which is incorporated herein by reference in its entirety.

### BACKGROUND OF THE INVENTION

1. Field of the Invention

The invention is in the field of electrical connectors, and more particularly in the field of latches for electrical connectors such as cable connectors.

2. Description of the Related Art

In the field of cable connectors, many types of latches meant to retain the cable in the mating connector have been used. Two basic types are in popular use today: a) a thumbscrew or jackscrew type; and b) a snap latch or lateral spring-loaded latch type.

In the thumbscrew or jackscrew type an actual screw is used to secure the connector or to disengage it. This type has the advantage that once engaged, the attachment is ridged and will easily support hanging cables and other external loads. It will be appreciated that movement of the connector from external loads is undesirable. If the connector is of very fine pitch, small movement can cause electrical problems. If the application is one of high frequency, small movement can cause electromagnetic interference (EMI) emissions.

A snap latch or lateral spring-loaded latch activates automatically when the connector is installed. Release is usually accomplished by a separate member that defeats the spring-loaded latch. This type has a latch that has a small overtravel in order to allow the lateral spring latch to engage. This over-travel fundamental to its operation can be fairly large in order to account for manufacturing tolerance and various source suppliers. The overlap is essentially an axial looseness that would allow external forces (i.e., hanging cables or the like) to move or change the position of the connector.

Improvements would be desirable in the field of latching mechanisms for cable connectors.

### SUMMARY OF THE INVENTION

According to an aspect of the invention, a latching mechanism for an electrical connector involves both axial and lateral spring forces.

According to another aspect of the invention, an electrical connector latch mechanism uses axial spring forces to better secure the electrical connector to a mating part.

According to yet another aspect of the invention, an electrical connector latching mechanism utilizes axial spring forces to pull hooks of the latching mechanism into secure engagement with receiving slots that receive the hooks.

According to still another aspect of the invention, an electrical connector latching mechanism includes axial springs that are compressed during latching, and that utilize the compressive forces to pull the electrical connector into tighter engagement with a mating receptacle or other part.

According to a further aspect of the invention, an electrical connector includes: a backshell; and a latch mechanism. The latch mechanism includes, on each side of opposite sides of the connector: a latch slideable in a backshell slot of the backshell, wherein the latch is a lateral cantilever spring and has a hook for engaging a corresponding receiving slot on a mating connector; a latch actuator arm of a latch actuator, wherein the latch actuator arm is slideable in the backshell slot; and an axial spring. A first end of the axial spring bears against a surface of the latch, and a second end of the spring bears against a surface of the backshell. The latch actuator arm is in contact with the latch such that movement of the latch actuator selectively moves the hook laterally toward and away from a centerline of the connector. Movement of the slide latch actuator selectively compresses and expands the axial spring.

According to another aspect of the invention, an electrical connector includes: a backshell; and a latch mechanism. The latch mechanism includes: a latch slideable in the backshell, wherein the latch has a hook for engaging a corresponding receiving slot on a mating connector; a latch actuator arm of a latch actuator, wherein the latch actuator arm is slideable in the backshell; and an axial spring. A first end of the spring bears a surface of the latch. A second end of the spring bears against a surface of the backshell. The latch actuator arm is in contact with the latch such that movement of the latch actuator selectively moves the hook toward and away from a centerline of the connector. Movement of the slide latch actuator selectively compresses or allows expansion of the spring.

According to a further aspect of the invention, an electrical connector includes: a backshell; and a latch mechanism. The latch mechanism includes: a pair of latches on opposite sides of the connector; means for resiliently selectively moving hooks of the latches laterally toward and away from a centerline of the connector; and axial springs that provide a spring force on the latches and the backshell in a direction substantially parallel to the centerline of the connector.

According to another aspect of the invention, a method of coupling together a first electrical connector and a second electrical connector includes the steps of: compressing at least one of a pair of axial springs of the first connector; electrically coupling respective sets of electrical contacts of the electrical connectors, while at the same time moving hooks of latches of the first connector toward receiving slots of the second connector; engaging the hooks with the receiving slots; and after the engaging, pulling the connectors together using spring forces from the compressed axial springs.

According to yet another aspect of the invention, a method of coupling together a first electrical connector and a second electrical connector includes the steps of: compressing at least one of a pair of springs; electrically coupling respective sets of electrical contacts of the electrical connectors, while at the same time moving a latch of the first connector toward a receiver of the second connector; engaging the latch with the receiver; and after the engaging, pulling the connectors together using spring forces from the compressed springs.

To the accomplishment of the foregoing and related ends, the invention comprises the features hereinafter fully described and particularly pointed out in the claims. The following description and the annexed drawings set forth in detail certain illustrative embodiments of the invention. These embodiments are indicative, however, of but a few of the various ways in which the principles of the invention may be employed. Other objects, advantages and novel features of the invention will become apparent from the following detailed description of the invention when considered in conjunction with the drawings.

### BRIEF DESCRIPTION OF THE DRAWINGS

In the annexed drawings, which are not necessarily to scale:

FIG. 1 is an oblique view of an electrical coupling utilizing an electrical connector latching mechanism in accordance with an embodiment of the present invention;

FIG. 2 is an oblique view of the electrical coupling of FIG. 1, with some parts removed for illustration purposes;

FIG. 3 is a view of part of the electrical coupling of FIG. 1, showing a first step in engagement of the latching mechanism;

FIG. 4A is a detailed view around a latch hook of FIG. 3;

FIG. 4B is a plan view of a portion of the coupling of FIG. 3;

FIG. 5A is a plan view of the coupling of FIG. 3;

FIG. 5B is a detailed view around a spring of FIG. 3;

FIG. 6 is an oblique view of the electrical coupling of FIG. 1, showing a second step in the latching operation;

FIG. 7 is a detailed view of the area around one of the latch hooks of the coupling of FIG. 6;

FIG. 8 is a plan view of a portion of the electrical coupling of FIG. 6;

FIG. 9 is an oblique view of parts of the electrical coupling of FIG. 1, illustrating the disengagement process of the latching mechanism;

FIG. 10 is a detailed view of the area around one of the latch hooks of the coupling of FIG. 9;

FIG. 11 is a plan view showing a portion of the electrical coupling, during the disengagement process of the latching mechanism;

FIG. 12 is a plan view of the coupling of FIG. 9; and

FIG. 13 is a detailed view around a spring of FIG. 9.

### DETAILED DESCRIPTION

An electrical connector has a latch mechanism that includes a pair of hooks that move resiliently outward from the center line of the connector, and a pair of axial springs mechanically coupled to latches that include the hooks. The axial springs provide force in a direction substantially parallel to the center line of the connector. The axial springs are compressed during initial parts of the process of mating of the connector with a receptacle or other connector. The energy from the compressed springs is then used to pull the connector and the receptacle more tightly together after the initial insertion. The axial spring forces maintain a tight grip between the connector and the receptacle, avoiding the play that is generally found in hook-based electrical connector latching mechanism. The latching mechanism provides a secure mechanical coupling between the connector and the receptacle, such as been previously obtained in screw-based couplings, but without the difficulties incurred from screwing and unscrewing such couplings.

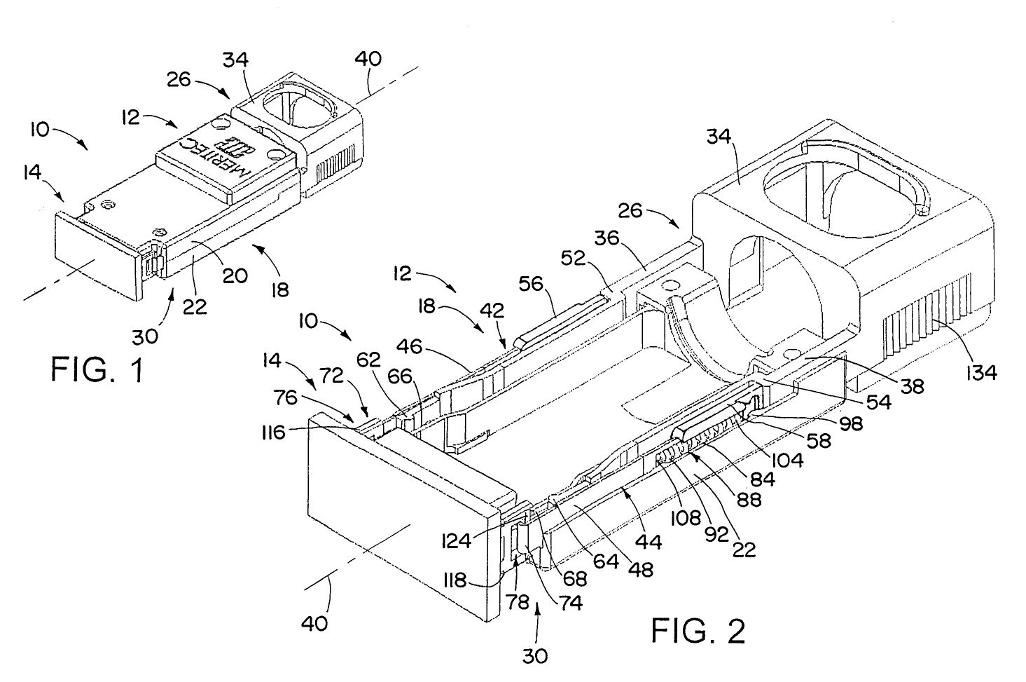

FIG. 1 shows an electrical coupling 10 in which an electrical connector 12 (also referred to herein as a “first connector”) is inserted into and is coupled to a receptacle 14 (also referred to herein as a “second connector”). The connector 12 and the receptacle 14 have respective sets of electrical conductors that are coupled to one another when the connector 12 and the receptacle 14 are coupled together. The electrical connector 12 includes a metal backshell 18 that encloses electrical conductors and their coupling to one or more cables (not shown). The backshell 18 includes a top backshell portion 20 and a bottom backshell portion 22, with the portions 20 and 22 held together by threaded fasteners such as screws. The first connector 12 also includes a latch actuator 26 that is part of a latching mechanism 30. The latch actuator 26 is movable relative to the backshell 18 in order to operate the latching mechanism 30 to selectively couple and decouple the electrical connector 12 to the receptacle 14.

With reference now in addition to FIG. 2, further details of the latching mechanism 30 are explained. The latch actuator 26 includes an actuator body 34 from which actuator arms 36 and 38 extend. The arms 36 and 38 are on opposite sides of the connector 12, equally spaced from a center line or center plane 40 of the connector 12. The actuator arms 36 and 38 are in respective slots 42 and 44 in the backshell 18. Movement of the actuator arms 36 and 38 within the backshell slots 42 and 44 engages latches 46 and 48 that are also located in the slots 42 and 44. The actuator arms 36 and 38 have step portions 52 and 54 which are in contact with and bear against overmolds 56 and 58 at ends of the latches 46 and 48. The latches 46 and 48 act as lateral spring cantilever beams. The ends of the beam closest to the step portions 52 and 54 have molded plastic bearings that allow the beam to travel axially in their respective slots 42 and 44, but restrict any rotation or lateral movement at the end. The opposite ends of the latches 46 and 48 have hooks 72 and 74 that can move laterally. The hooks 72 and 74 are used to engage receiving slots 76 and 78 on opposite sides of the receptacle or second connector 14. The hook ends of the latches 46 and 48 resiliently move outward when pushed outward by the actuator arm distal ends 62 and 64, or by material around the receiving slots 76 and 78. Distal ends 62 and 64 of the actuator arms 36 and 38 are located between and bear against the latches 46 and 48, and respective ramps 66 and 68 on inner surfaces of the backshell slots 42 and 44.

Pulling the latch actuator 26 away from the backshell 18 causes the distal ends 62 and 64 to move outward along the sloped ramps 66 and 68. Movement of the actuator arm back toward the backshell 18 causes the distal ends 62 and 64 to move in the opposite direction, allowing the hooks 72 and 74 of the latches 46 and 48 to move back inward, toward the center line and center plane 40.

The latching mechanism 30 also includes a pair of axial coil springs that are located in the backshell slots 42 and 44. Only one of the springs, a spring 84, is shown in the figures. The springs are also located in latch cutouts or slots (only one of the slots, a slot 88, is visible), of the latches 46 and 48. A first end 92 of the spring 84 bears against an edge 98 of the latch 48, at an end of the latch cutout or slot 88 farthest from the latch hook 74. A similar first end of the other spring bears against an edge of the latch 46. A second spring end 104 bears against a ledge 108 in the backshell slot 44 of the backshell 18. A similar second spring end bears against a ledge in the backshell slot 42. As explained in greater detail below, the springs are used for firmly securing the connectors 12 and 14 together.

The receptacle 14 includes the receiving slots 76 and 78 for receiving the hooks 72 and 74 of the latches 46 and 48. The receiving slots 76 and 78 are in respective latch-receiving protrusions 116 and 118 of the receptacle 14. The latch-receiving protrusions 116 and 118 have sloped or ramped surfaces, such as the ramped surface 124, that resiliently deflect the hooks 72 and 74 laterally outward as the hooks 72 and 74 are moved toward the receiving slots 76 and 78.

The actuator body 34 has grips, such as the grip 134, on opposite side surfaces. The grips enable better griping of the latch actuator 26 by a user. The grips may be textured surfaces, such as series of ridges.

Various parts of the connectors 12 and 14 may be made from a variety of suitable well-known materials. The latch actuator 26 may be made of molded plastic. The backshell 18 may be made of steel or another suitable metal. The latches 46 and 48 may be made of spring steel or another suitable metal material. The hooks 72 and 74 may have a suitable low-friction material for reducing friction between the hooks 72 and 74 and edges of the receiving slots 76 and 78. An example of a suitable low-friction material with for the hooks 72 and 74 is a plastic overmold on the hooks 72 and 74. Such a plastic overmold is described in U.S. application Ser. No. 11/942,888, filed Nov. 20, 2007, the detailed description and drawings of which are incorporated herein by reference. The latch-receiving protrusions 116 and 118 of the receptacle 14 may be made of steel or another suitable metal.

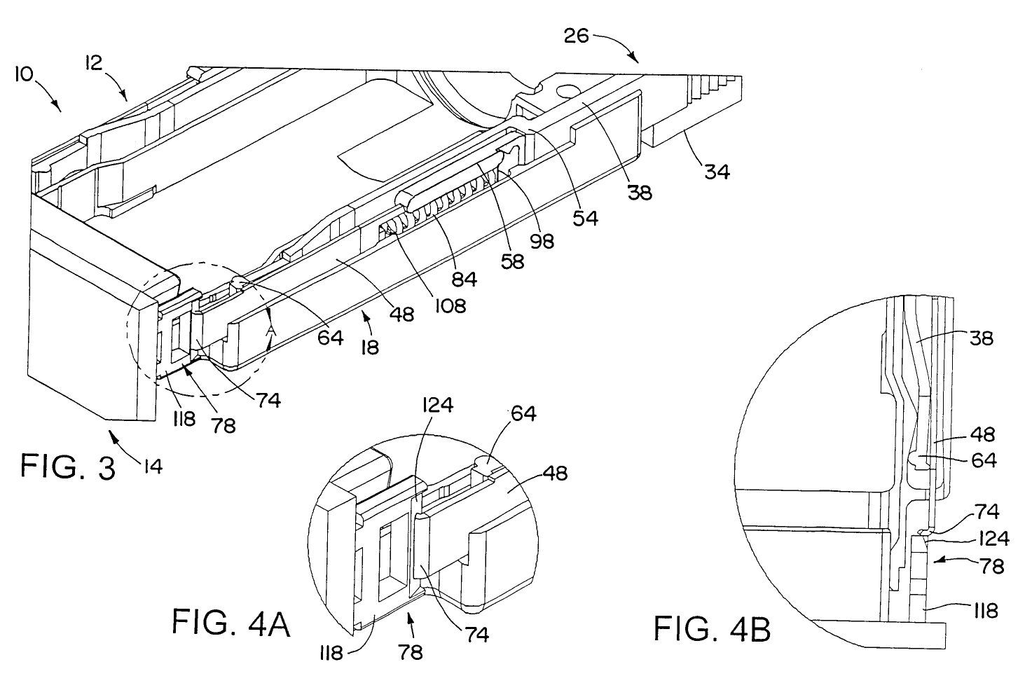

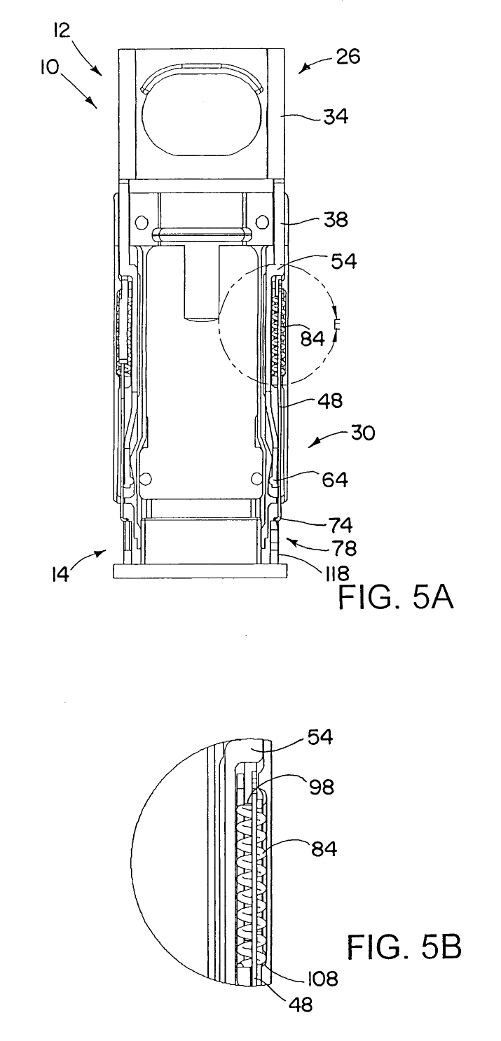

FIGS. 3-5B show a first step in engagement of the connector 12 into the receptacle 14. The explanation below is provided with regard to the parts on one side of the connector 12, the side with the hook 48. It will be appreciated that corresponding parts are simultaneously being moved on the other side of the connector 12, as can be seen in FIG. 5A.

The illustrated latching process begins with the connector 12 already adjacent to the receptacle 14. The actuator body 34 of the latch actuator 26 is gripped and moved forward relative to the backshell 18. This causes the actuator arm 38 to move forward as well. The actuator arm step portion 54 presses against the latch overmold 58. This drives the latch forward (towards the receptacle 14) relative to the backshell 18. As this happens the spring 84 is compressed, as best seen in FIG. 5B. Energy stored in the compressed spring will be used later to tighten the coupling between the electrical connector 12 and the receptacle 14.

The compressing of the spring requires additional force to be put in by the user. For example, 10 pounds of total force may be required to mate the connectors 12 and 14. Typically, the connector mating force will be smaller than the force required to compress the axial springs to the working load. Therefore, the connector will be fully engaged before the axial spring is totally compressed. As an example, the connector may require an initial force of five (5) pounds to engage, but the axial spring will require ten (10) pounds to engage the latch.

As the latch 48 moves forward the hook 74 contacts the ramped or sloped surface 124 of the latch-receiving protrusion 118. This causes the hooked end of the latch 48 to deflect outward as a cantilever beam. This allows the hook 74 to move outwardly around the latch-receiving protrusion 118. As this process continues the electrical connector becomes mated with the receptacle 14. When the axial spring has been sufficiently compressed, the hook 48 moves far enough forward that the hook 48 reaches the receiving slot 78. When this happens the lateral spring forces from the cantilevered flexing of the latch 48 cause the hook 74 to snap into the receiving slot 78. The electrical connector 12 is now mechanically coupled to the receptacle 14, with the spring 84 still compressed. The latching mechanism 30 is now engaged, so as to allow the user to release engagement force or pressure on the actuator body 34 that was pushing the electrical connector 12 toward the receptacle 14.

In typical engagement processes, at the beginning of engagement of a connector and a receptacle, force rises sharply to a peak generally attributed to the entry geometry and the required force to move the mating connector elements. Forces for the initial engagement include frictional forces, and forces for cantilever bending of conductors and/or latches. Once initial entry is made, the force subsides to a normal friction force.

In the present coupling 10, the entry force is applied by compressing the axial springs, such as the spring 84. After the peak forces are reached, the springs will unload (release some of the energy put into them by compression), to shove the connector home. This action results in a very unique feel of positive or snap engagement. There will be no doubt as to whether the connector has been seated. This is in contrast to prior systems where the tactile feel does not give very positive feedback.

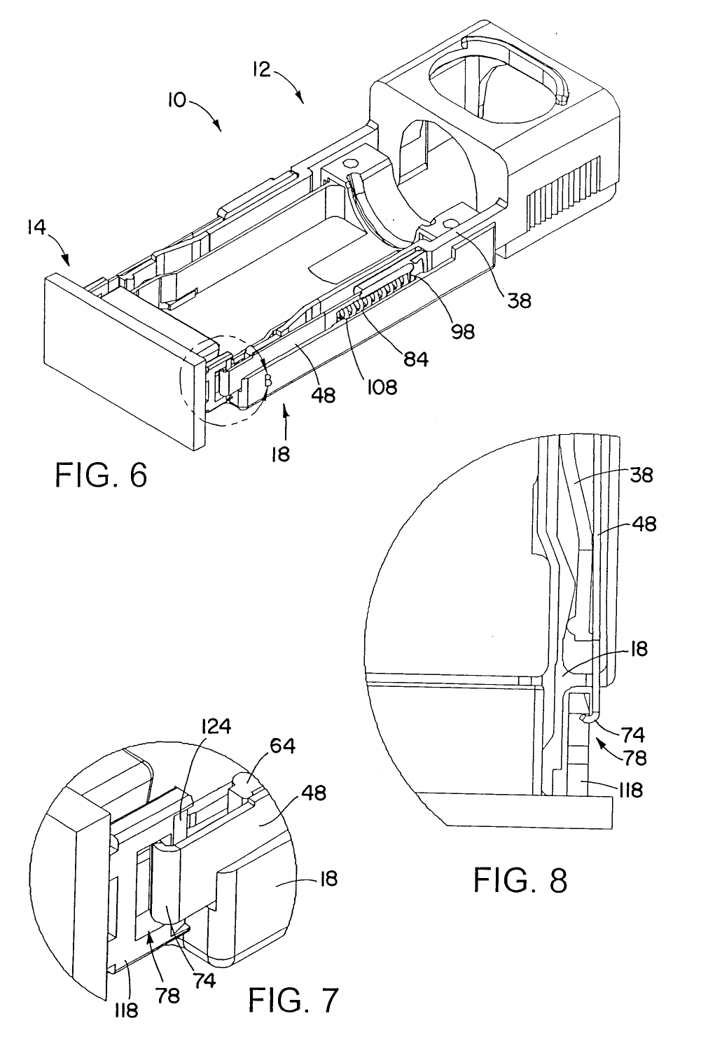

After the hooks have engaged the receiving slots, the actuator body 34 may be released by the user, and the stored energy in the spring 84 is used to more firmly secure together an electrical connector 12 and the receptacle 14. This is illustrated in FIGS. 6-8. The spring force from the compressed spring 84 presses simultaneously in two directions. First the spring force presses back against the latch edge 98. This pushes the latch 48 back toward the backshell 18. This pulling of the latch 48 backwards brings the hook 84 up tight against the edge of the receiving slot 78. This removes any play that there might be between the hook 74 and the sides of the receiving slot 78. Such play may result from overtravel included in the configuration of the latch mechanism.

Simultaneously the spring 84 pushed forward against the ledge 108. This drives the entire backshell 18 further forward, into better engagement with the receptacle 14. The energy from the compression of the spring 84 is thus used to secure the electrical connector 12 to the receptacle 14 in two ways, by securing the hook 74 into firm engagement with latch-receiving protrusion 118, and by pulling the electrical connector 12 into solid engagement with the receptacle 14. The result is a solid coupling between the electrical connector 12 and the receptacle 14, a coupling that does not have any significant play or wobble to it. The resulting coupling may be secured to a degree that is achievable by screw-based couplings, without requiring the relatively long and tedious process of turning screws or other threaded fasteners. This is a particular advantage with cable connectors, since forces from hanging cables may pull or push on the connector 12.

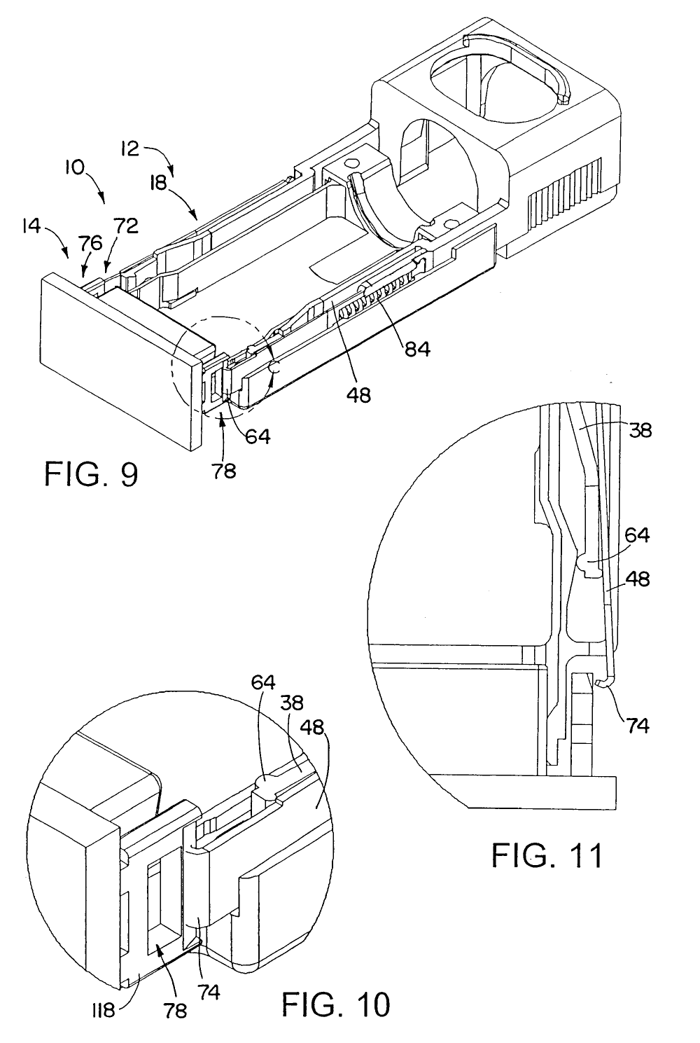

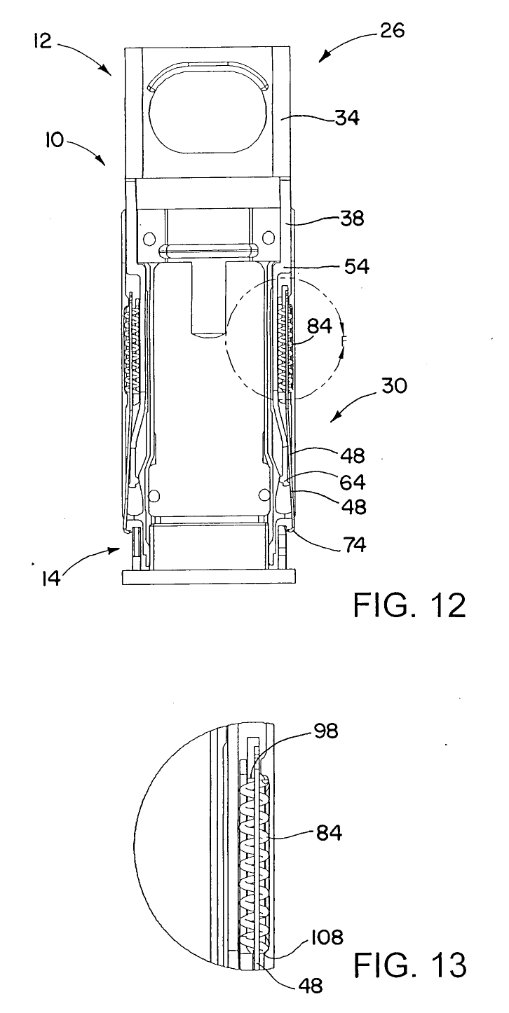

FIGS. 9-13 illustrate an unlatching process for the latching mechanism 30. Disengagement is accomplished by a simple pulling of the latch actuator 26 away from the receptacle 14. As shown best in FIGS. 11 and 12, this pulling causes the actuator arm distal end 64 to move radially outward as it moves back along the ramped surface 68. The contact between the actuator arm end 64 and the latch 48 pushes the hook 74 outward in a cantilevered fashion. It is desirable that the coefficient of friction between the hook 74 and the edge of the receiving slot 78 be relatively low, so that the hook 74 moves laterally outward easily under the action of the actuator arm end 64. Once the hook 74 is clear of the receiving slot 78, the remaining compressive forces in the spring 84 pull the latch 48 back, away from the receptacle 14, with the hook 74 moving toward the backshell 18. The spring 84 expands until it reaches is uncompressed length, as best seen in FIG. 13. This disengages the latching mechanism 30, and allows the electrical connector 12 to be separated from the receptacle 14.

The latching mechanism described herein has the advantage of providing very secure mechanical connection between the electrical connector 12 and the receptacle 14. In addition, the engagement of the hooks 72 and 74 into the receiving slots 76 and 78 will provide a very secure engagement. This positive or snap engagement provides a unique tactile feel to the user that is easily interpreted by the user as the making of the latching connection between the connector 12 and the receptacle 14.

It will be appreciated that the embodiment shown in the figures and described above is only one example. Many variations are possible. For example, the hooks 72 and 74 and the receiving slots 76 and 78 are only one type of a latching mechanism. More broadly, the latching mechanism may include one or more latches that engage one or more receivers. The latches may be any of a variety of shapes that engage suitably-shaped receivers. One part of the latching mechanism (the one or more latches or the one or more receivers) may be rigid or non-compliant, while the other part may be springable or compliant. Alternatively, both parts of the latching mechanism may be springable or compliant.

Although the invention has been shown and described with respect to a certain preferred embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

1. An electrical connector comprising:
a backshell; and
a latch mechanism that includes:
a latch slideable in the backshell, wherein the latch has a hook for engaging a corresponding receiving slot on a mating connector;
a latch actuator arm of a latch actuator, wherein the latch actuator arm is slideable in the backshell; and
an axial spring;
wherein a first end of the spring bears against an aft surface of the latch;
wherein a second end of the spring bears against a forward surface of the backshell;
wherein the latch actuator arm is in contact with the latch such that movement of the latch actuator selectively moves the hook toward and away from a centerline of the connector; and
wherein movement of the slide latch actuator selectively compresses or allows expansion of the spring.

2. The connector of claim 1, wherein the latch includes a hook.

3. The connector of claim 1, wherein the axial spring is a coil spring.

4. The connector of claim 1, wherein the spring is located at least in part in a slot in the latch.

5. The connector of claim 1, wherein the latch includes a plastic overmold that bears against a step portion of the actuator arm, and becomes a bearing surface confining the latch to axial movement at the actuator end while still allowing lateral movement at the hook end.

6. The connector of claim 1, wherein the latch actuator arm is part of a latch actuator that is a single piece of material.

7. The connector of claim 6, wherein the latch actuator also includes an actuator body that is movable relative to the backshell.

8. The connector of claim 1, wherein the first end of the spring is between the hook and the second end of the spring.

9. The connector of claim 1, wherein an actuator arm end of the actuator arm bears against the latch and against a sloped surface of the backshell, to move the hook away from the centerline of the connector.

10. The connector of claim 1, wherein the hook includes a plastic overmold that provides a low-friction engagement with the receiving slot.

11. The connector of claim 1, wherein the latch mechanism also includes:
an additional latch slideable in the backshell, wherein the additional latch has a hook for engaging a corresponding receiving slot on the mating connector;
an additional latch actuator arm of the latch actuator, wherein the additional latch actuator arm is slideable in the backshell; and
wherein the additional latch actuator arm is in contact with the additional latch such that movement of the additional latch actuator selectively moves the hook of the additional latch toward and away from the centerline of the connector.

12. The connector of claim 1, wherein the connector is a cable connector.

13. An electrical connector comprising:
a backshell; and
a latch mechanism that includes:
a pair of latches on opposite sides of the connector;
means for resiliently selectively moving hooks of the latches laterally toward and away from a centerline of the connector; and
springs that provide a spring force on the latches and the backshell in a direction substantially parallel to the centerline of the connector.

14. The connector of claim 13,
wherein the means for resiliently moving include actuator arm ends of a latch actuator of the latch mechanism; and
wherein the actuator arm ends bear against the latches and against sloped surfaces of the backshell, to move the hooks away from the centerline of the connector.

15. A method of coupling together a first electrical connector and a second electrical connector, the method comprising:
compressing at least one spring;
electrically coupling respective sets of electrical contacts of the electrical connectors, while at the same time moving a latch of the first connector toward a receiver of the second connector;
engaging the latch with the receiver; and
after the engaging, pulling the connectors together using spring forces from the compressed at least one spring.

16. The method of claim 15, wherein the pulling includes pulling a backshell of one of the connectors into engagement with the other of the connectors.

17. The method of claim 16, wherein the pulling also pulls the latch into tight engagement with the receiver, thereby eliminating play between the latch and the receiver.

18. The method of claim 15, wherein the compressing includes moving at least one of a pair of latch actuator arms of one of the connectors toward the other of the connectors, to thereby compress the at least one spring.

19. The method of claim 18,
wherein the actuator arms are part of a latch actuator; and
wherein the compressing includes moving the latch actuator as a unit relative to a backshell of the first connector.

20. The method of claim 15,
wherein the latch includes one or more hooks; and
wherein the receiver includes one or more receiving slots that receive the one or more hooks.
